(19) United States
(12) Patent Application Publication
(10) Pub. No.: US 2007/0113268 A1
(43) Pub. Date: May 17, 2007

(54) Intrusion resistant passive fiber optic components

(76) Inventors: Cary R. Murphy, Newton, NC (US); Mark K. Bridges, Hickory, NC (US); David E. Vokey, Sydney, BC (CA)

Correspondence Address: ADE & COMPANY INC., 2157 Henderson Highway, WINNIPEG, MB, R2G1P9, CA

(21) Appl. No.: 11/461,668

(22) Filed: Aug. 1, 2006

Related U.S. Application Data
(60) Provisional application No. 60/704,992, filed on Aug. 3, 2005.

(51) Int. Cl. H04L 9/32

(52) U.S. Cl. 726/2

(57) ABSTRACT

In a method for secure transmission of data using a quantum key distribution system where individual photons each having a state of polarization are transmitted from the source to the recipient and where the state of polarization the photons is used to provide the series of bits of the encryption key, manipulation of the optical fiber causing movement of a portion of the fiber indicative of an intrusion event is obtained by analyzing changes in time of the number of dropped bits which is those bits which fail to be accurately detected by the recipient since such changes are indicative of changes in polarization of the photons due to handling of the fiber.

This application claims the benefit of the priority date under 35 USC 119 from Provisional Application 60/704,919 filed Aug. 3, 2005.

This invention relates to a method secure transmission of data using a quantum key distribution system.

### BACKGROUND OF THE INVENTION

A shortcoming of key based encryption systems used for data security is maintenance of the key. The key is a “shared secret” which users at each end of a communication channel must both know, but any intruder must not. In secure networks, much effort is expended in keeping this key secret, because when the key is known the data can be decrypted.

One method used for this key encryption is a system called quantum key distribution (QKD). This system rapidly changes the key, and transmits the new key over an optical fiber is such a way that interception of the key is detected by virtue of the transmission method. This method relies upon laws of quantum electrodynamics, which state that monitoring any event at the atomic or subatomic level changes that event.

How this is accomplished in QKD is to broadcast the key as an individual photon per bit of data, and at a controlled state of polarization. The measurement of the state of polarization (SOP) in fact alters that very state. This precludes an eves-dropper from learning the key.

In a Quantum Key Distribution System (QKD), two sets of transmissions are present between the source at one end and the recipient at the other end. The data path carries encrypted high-speed information, similar to what would be carried on a secure network. The key path carries a low-speed key to the encryption, used for decoding the information on the data path, and which is constantly being changed. This key is encrypted at the quantum level, with a single photon per data bit. The most common method of quantum encoding is with changing the SOP.

The encryption key is based on a series of bits and systems for key based encryption using such keys are well known to persons skilled in this art. The encryption key is transmitted from the source to the recipient along an optical fiber using a series of individual photons each having a state of polarization and the state of polarization of the series of photons as transmitted by the source is detected at the recipient. It is well known that the polarization of each photon cannot be detected without changing its state of polarization. A communications protocol between the source and the recipient is arranged to determine which of the bits defined by the state of polarization of the stream of photons are used in the key. This communications protocol acts to select the bits without revealing in the communications what is the content of those bits.

Inherently in the system some of the bits are lost or mis-communicated so that their content is lost. It will be appreciated that the determination of the phase of a photon is difficult and is required to be effected at a considerable distance from the source and errors occur for various reasons within the system. The typical protocol used at this time includes a system for detecting such bits which fail to be accurately detected by the recipient which are considered as “dropped bits”. Of course such bits cannot be used in the key and both the source and the recipient must know what and where those bits are.

Thus in current systems, the change in SOP of the key leg of a Quantum Key Distribution system is monitored for reception of the key using standard polarization detection techniques, and dropped bits in the key path cause the key to be rebroadcast or changed.

### SUMMARY OF THE INVENTION

It is one object of the present invention to provide an improved method for secure communication of data using the QKD system.

According to the invention therefore there is provided a method for secure transmission of data comprising:

transmitting data from a source to a recipient;

at the source encrypting the data using a secret encryption key;

at the recipient decrypting the encrypted data using the secret encryption key;

the encryption key being based on a series of bits;

transmitting the encryption key from the source to the recipient along an optical fiber using a series of individual photons each having a state of polarization;

wherein the state of polarization of at least some of the series of the photons is used to provide the series of bits of the encryption key;

wherein the polarization of each photon cannot be detected without changing its state of polarization or otherwise affecting the photon;

wherein the state of polarization of the series of photons as transmitted by the source is detected at the recipient;

wherein the photons to be used for the series of bits is determined by a communications protocol between the source and the recipient;

and wherein the communications protocol includes detecting a number of bits which fail to be accurately detected by the recipient;

and detecting manipulation of the optical fiber causing movement of a portion thereof along the length thereof indicative of an intrusion event by analyzing changes in time of the number of bits which fail to be accurately detected by the recipient.

In this invention, incidents of dropped bits are analyzed, potentially revealing fiber handling as a possible prelude to theft or to more damaging intrusion. Transmission can be then discontinued or misinformation transmitted.

Detection or measurement of the handling or disturbance of the optical fiber or cable in the key path, either as a prelude to, incident of, or as a result of an intrusion, as detected by any shift in the degree or state of polarization of any portion of the light contained therein, originating from, or propagating through the optical fiber or cable carrying the key signal.

### BRIEF DESCRIPTION OF THE DRAWINGS

One embodiment of the invention will now be described in conjunction with the accompanying drawings in which:

FIG. 1 is a schematic illustration of a Quantum Key Distribution system according to the present invention.

FIGS. 2 to 6 are schematic illustrations of algorithms for use in the system according to the present invention for analyzing the numbers of dropped bits.

In the drawings like characters of reference indicate corresponding parts in the different figures.

### DETAILED DESCRIPTION

Handling of the fiber cable causes a local mechanical disturbance to the fiber. This mechanical disturbance, while not introducing detectable macro or micro bending losses, causes the polarization orientation to change. This is detected by the dropping of bits and reported to the processor. A more comprehensive view is now described.

This is forwarded to the processor where the signal is filtered to eliminate normal environmental background noise. The filtered signal is then analyzed for transient signatures and level changes that are characteristic of cable and fiber handling. At a pre-set disturbance level or slope change the circuit activates the alarm response.

Since intrusions tend to be very slow occurrences, on the order of hundreds of milliseconds, there is ample time to average readings under each measurement state.

The processing required for signal analysis of an intrusion detection system is not insignificant, algorithms which analyze the environment and filter out disturbances to be ignored are highly computationally intensive.

The processing to determine handling is not insignificant, and can be accomplished in several ways including, but not limited to: Threshold Detection, Leaky Bucket Filtering, Frequency Envelope Detection (FED), and Waterfall FED.

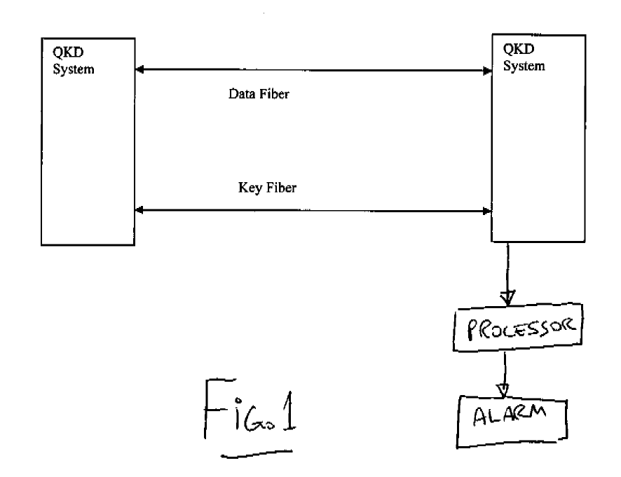

Threshold Detection as shown in FIG. 1 is a simple monitoring the transient level of the signal exiting the key leg of the QKD system. When the level changes more than a pre-determined level, an alarm is registered. Due to the nature of states of polarization, this change can be positive or negative in direction.

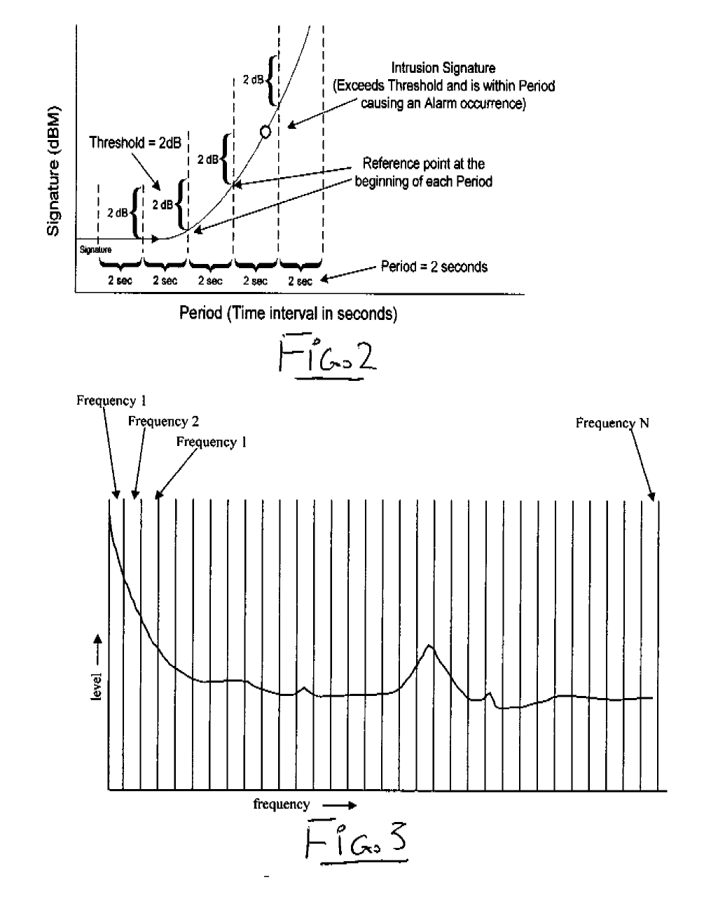

In FIG. 2, a time element is added to threshold detection, this includes the so-called Leaky Bucket analysis. In this figure, at the beginning of each time window the level is referenced. A signal of larger than normal shift or faster than normal slew during any time slice will register an alarm. The system installation should be characterised to determine what is a suitable threshold.

FIG. 3 shows a frequency spectrum of the change in amplitude of the key leg. Since the key leg consists of individual photons, these detections may be integrated, or otherwise processed, to create a usable quasi-continuous waveform for analysis. This spectrum is “sliced” into manageable sections for discrete analysis.

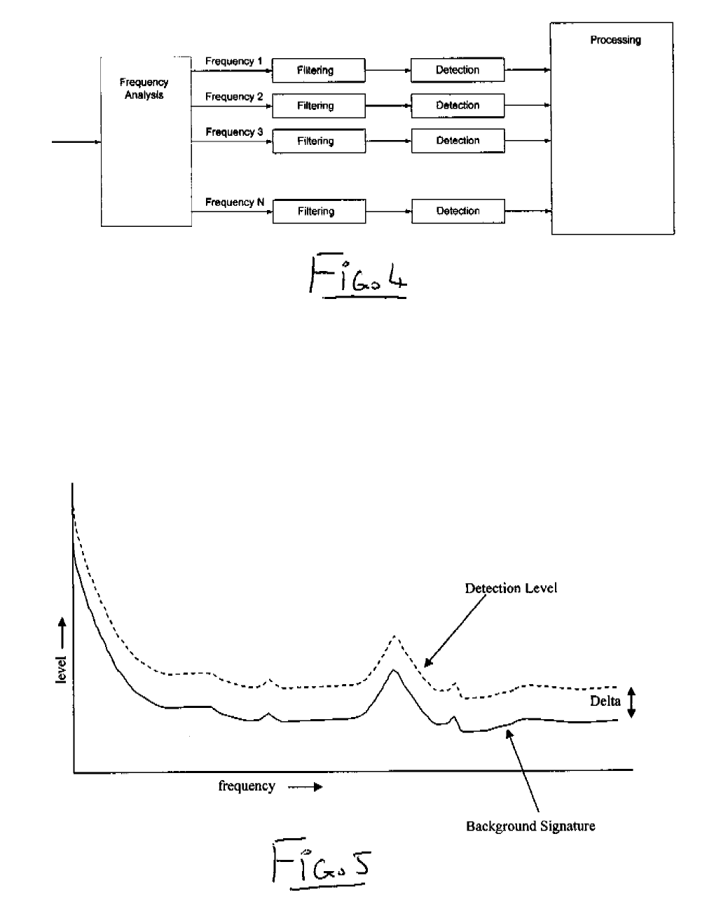

FIG. 4 illustrates taking the slices from FIG. 3 and processing them individually. For example, a “leaky bucket” as described above, or other filtering and detection mechanisms, could be applied to each slice. This will help to diminish sensitivity to any period ambient signatures in the signal, such as a vibrating fiber.

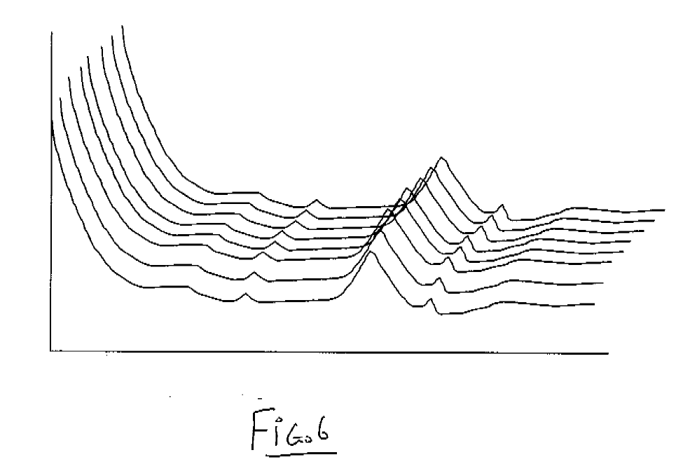

FIG. 5 is an illustration of frequency envelope detection, where a spectra of a “normal” condition is compared to that of the current or stored condition, and compared for detection of anomaly—signifying fiber perturbation

FIG. 6 represents a Waterfall FED, which adds another dimension to the analysis. Fiber perturbation not only contain both amplitude and frequency components, but the frequency components change, or evolve, over time. Analysis of this evolution can help discriminate a perturbation from an ambient event.

Reference is made to co-pending Application Ser. No. INSERT filed on the same day as the present application (attorney docket 85570-702) entitled FREQUENCY ENVELOPE DETECTION METHOD FOR SIGNAL ANALYSIS which provides additional disclosure in relation to the above techniques, the disclosure of which is incorporated herein by reference.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for secure transmission of data comprising:
transmitting data from a source to a recipient;
at the source encrypting the data using a secret encryption key;
at the recipient decrypting the encrypted data using the secret encryption key;
the encryption key being based on a series of bits;
transmitting the encryption key from the source to the recipient along an optical fiber using a series of individual photons each having a state of polarization;
wherein the state of polarization of at least some of the series of the photons is used to provide the series of bits of the encryption key;
wherein the polarization of each photon cannot be detected without changing its state of polarization or otherwise affecting the photon;
wherein the state of polarization of the series of photons as transmitted by the source is detected at the recipient;
wherein the photons to be used for the series of bits is determined by a communications protocol between the source and the recipient;
and wherein the communications protocol includes detecting a number of bits which fail to be accurately detected by the recipient;
and detecting manipulation of the optical fiber causing movement of a portion thereof along the length thereof indicative of an intrusion event by analyzing changes in time of the number of bits which fail to be accurately detected by the recipient.
